(19) United States
(12) Patent Application Publication
(10) Pub. No.: US 2009/0114658 A1
(43) Pub. Date: May 7, 2009

(54) Float-Based Automatic Drain Valves And Related Methods

(76) Inventor: David Kumhyr, Austin, TX (US)

Correspondence Address: LATHROP & GAGE LC, 4845 PEARL EAST CIRCLE, SUITE 201, BOULDER, CO, 80301, US

(21) Appl. No.: 12/263,248

(22) Filed: Oct. 31, 2008

Related U.S. Application Data
(60) Provisional application No. 60/984,525, filed on Nov. 1, 2007.

(51) Int. Cl. F16T 1/20; F17C 1/00

(52) U.S. Cl. 220/581; 137/192; 29/890.12

(57) ABSTRACT

A float-based automatic drain valve automatically drains fluid from a compressed air cylinder; the cylinder includes a chamber with an inlet and an outlet. The inlet is formed at the top of the chamber and connects to a low point of the compressed air cylinder to receive fluid therefrom. The outlet is formed at the bottom of the chamber for discharging the fluid. A buoyant stopper disposed within, and not attached to, the chamber, seals the outlet when insufficient fluid is present within the chamber to float the buoyant stopper. Further, the buoyant stopper unseals the outlet and discharges the fluid when buoyancy of the stopper within the fluid overcomes forces seating the buoyant stopper at the outlet.

### RELATED APPLICATIONS

This application claims priority to U.S. Provisional Application Ser. No. 60/984,525 filed Nov. 1, 2007, which is incorporated herein by reference.

### FIELD OF THE INVENTION

A float-based automatic drain valve drains liquid (e.g., water) that is condensed from compressed air from a compressed air cylinder. More specifically, collected water from the compressed air cylinder is discharged automatically when sufficient water accumulates inside the drain valve to float a buoyant stopper.

### BACKGROUND

Air typically contains of a certain amount of water vapor. When air is compressed, the water vapor condenses into a liquid (i.e., water). This phenomenon leads to accumulation of water within a pressurized air cylinder, particularly when operation of a compressor is frequent and/or when the relative humidity of the air being compressed is high. To remove the water from the air cylinder, the air cylinder is depressurized and the liquid is drained using a drain valve. However, the task of draining water from the air cylinder is often forgotten or neglected, leaving water accumulation within the cylinder. The water causes the air cylinder to rust internally and eventually fail.

A self-regulating electric drain valve may be used to automatically remove water from the air cylinder, but these devices are expensive and cumbersome to fit, particularly to non-commercial or home air cylinders.

### SUMMARY OF THE INVENTION

In one embodiment, a float-based automatic drain valve automatically drains fluid from a compressed air cylinder. The float-based automatic drain valve has a chamber with an inlet and an outlet. The inlet is formed at the top of the chamber that connects to a low point of the compressed air cylinder to receive fluid therefrom. The outlet is formed at the bottom of the chamber for automatically draining the fluid. A buoyant stopper is disposed within, and not attached to, the chamber. The buoyant stopper seals the outlet when insufficient fluid is present within the chamber. The buoyant stopper unseals the outlet when buoyancy of the stopper within the fluid overcomes forces seating the buoyant stopper at the outlet.

In another embodiment, a method manufactures a float-based automatic drain valve for a compressed air cylinder. The method forms an upper portion of a chamber with a hollow interior, and a lower portion of the chamber with a hollow interior. The method forms an inlet at the top of the upper portion of the chamber, an outlet at the bottom of the lower portion of the chamber, and a seat at the inside of the outlet. The method places a buoyant stopper within the lower portion of the chamber. Finally, the method joins the upper and-lower portions of the chamber to encapsulate the buoyant stopper.

In another embodiment, a method drains fluid from a compressed air cylinder using a float-based automatic drain valve. The method seals an outlet of a chamber of the float-based automatic drain valve with a buoyant stopper. The method accumulates fluid from the compressed air cylinder in the chamber. The method floats the buoyant stopper in the accumulated fluid to un-seal the outlet, and discharges the fluid from the chamber through the outlet.

In yet another embodiment, an air cylinder system has a cylinder for holding compressed air, and a float-based automatic drain valve that is in fluid communication with the cylinder. The float-based automatic drain valve forms a chamber into which fluid from the cylinder drains. A buoyant stopper seals the chamber to prevent fluid and compressed air draining from the chamber if there is insufficient fluid to float the buoyant stopper within the chamber. The buoyant stopper unseals the chamber, such that fluid drains from the chamber, if the buoyant stopper floats in the fluid within the chamber.

### BRIEF DESCRIPTION OF THE FIGURES

FIG. 1 shows a float-based automatic drain valve coupled to an air cylinder, according to an embodiment

FIGS. 2A-2C illustrate additional detail and operation of the float-based automatic drain valve of FIG. 1.

FIG. 3 is an exploded view illustrating use of a threaded pipe to connect the float-based automatic drain valve of FIG. 1 to the compressed air cylinder.

FIG. 4 is a flowchart illustrating one exemplary process for manufacturing the float-based automatic drain valve of FIG. 1, according to an embodiment.

FIG. 5 is a flowchart illustrating one exemplary process for automatically draining water from a compressed air cylinder using the float-based automatic drain valve of FIG. 1, according to an embodiment.

### DETAILED DESCRIPTION OF THE FIGURES

Reference will now be made to the attached drawings, where multiple elements within a figure may not be labeled for the sake of clarity, and the figures may not be drawn to scale.

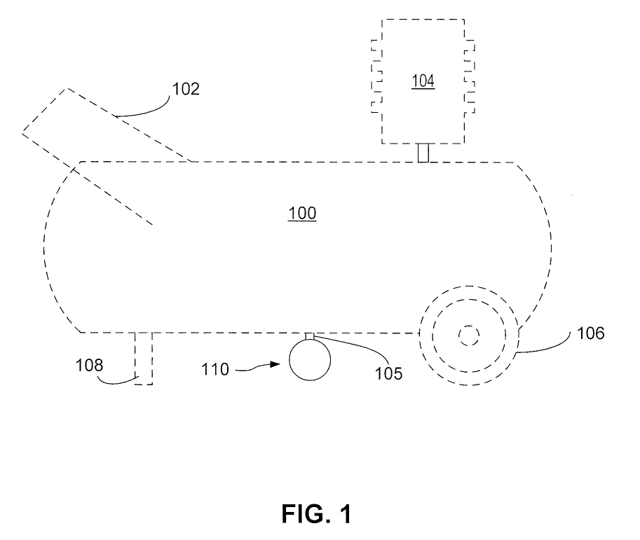

FIG. 1 shows a float-based automatic drain valve 110 coupled to a compressed air cylinder 100. Compressed air cylinder 100 is also coupled to an air compressor 104 that compresses air into cylinder 100. Float-based automatic drain valve 110 is attached to air cylinder 100 by a pipe 105 such that water, condensed from the compressed air within air cylinder 100, drains into float-based automatic drain valve 110. That is, automatic drain valve 110 attaches to a low (preferably the lowest) gravitational point of air cylinder 100. Compressed air cylinder 100 is shown with a handle 102, at least one wheel 106, and a stand 108 as often found on non-commercial and residential compressed air cylinders. In one embodiment, automatic drain valve 110 may be directly attached to cylinder 100 (e.g., without use of pipe 105).

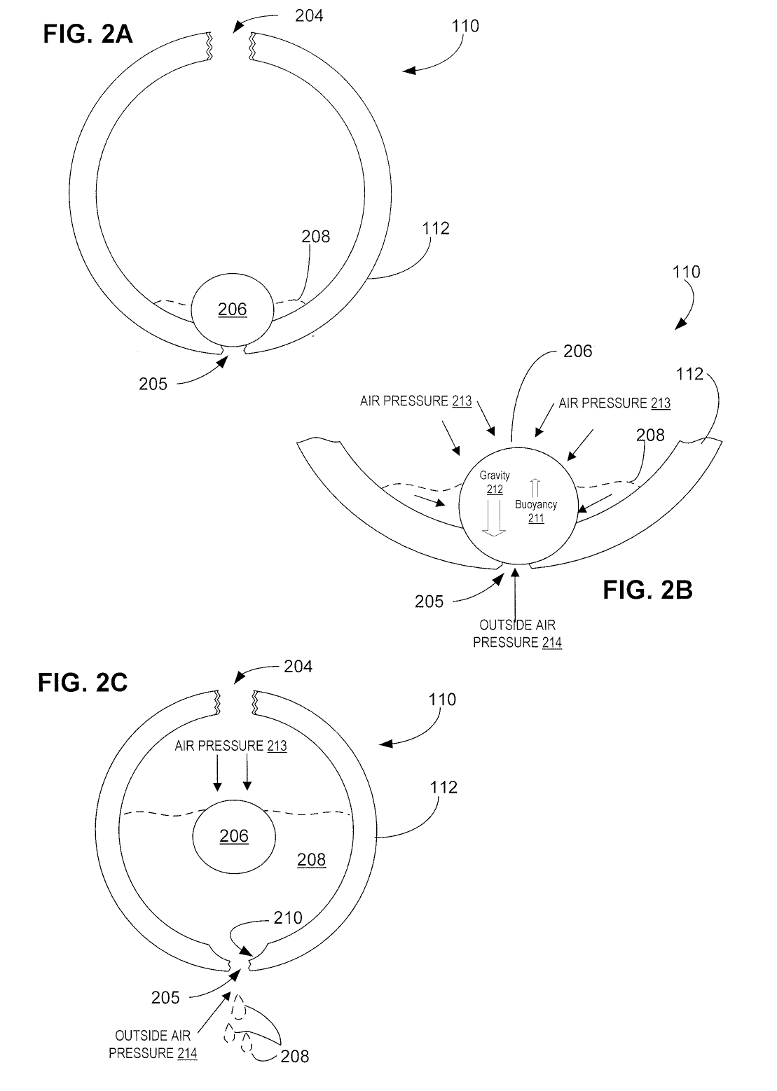

FIGS. 2A-2C illustrate exemplary detail and operation of float-based automatic drain valve 110 of FIG. 1. FIGS. 2A-2C are best viewed together with the following description. FIG. 2A shows a cross-sectional view of float-based automatic drain valve 110 of FIG. 1. Float-based automatic drain valve 110 forms a chamber 112 with an inlet 204, an outlet 205; a buoyant stopper 206 inside chamber 112 is not attached. Accordingly, buoyant stopper 206 is free floating within chamber 112. Inlet 204 is formed at the top of chamber 112 and receives gas and fluid (i.e., compressed air and water) from air cylinder 100. Inlet 204 is threaded for connection to pipe 105. Outlet 205 is formed at the bottom of chamber 112 to discharge water 208 accumulated within chamber 112.

Buoyant stopper 206 is free floating within chamber 112 and functions to seal outlet 205 when insufficient water is present within chamber 112 to float buoyant stopper 206. That is, absent of water 208, gravity and air pressure differential causes buoyant stopper 206 to seal outlet 205. As shown in FIG. 2B, when a small amount of water 208 (or no water) is present within chamber 112, a buoyancy force 211 is insufficient to overcome the force of gravity 212 and the pressure differential between air pressure 213 within chamber 112 and air pressure 214 external to chamber 112 (i.e., prevailing atmospheric pressure). As shown in FIG. 2C, when sufficient water 208 accumulates within chamber 112 and the differential air pressures 213, 214 is sufficiently small, buoyancy force 211 becomes greater than the force of gravity 212 and differential air pressures 213, 214, such that buoyant stopper 206 floats, thereby unsealing outlet 205 to release water 208 from chamber 112. As shown in FIG. 2C, a seat 210 may be formed at outlet 205 to receive buoyant stopper 206 and improve the seal between buoyant stopper 206 and chamber 112 when buoyant stopper 206 is seated at outlet 205. Optionally, a sealing ring (not shown) may be located within seat 210.

It should be noted that buoyancy force 211 may be assisted by vibrational forces of air cylinder 100 (such as during operation of the air compressor employing air cylinder 100). Accordingly, buoyancy stopper 206 may unseal in presence of such vibration when buoyancy alone would have not have been sufficient to float buoyancy stopper 206.

Components of float-based automatic drain valve 110 may be fabricated from one or more materials such as stainless steel, anti-corrosive metals, polypropylene and other plastics. Buoyant stopper 206 may be fabricated from one or more of polypropylene, anti-corrosive metal, and other plastics. Buoyant stopper 206 may be hollow to increase buoyancy and may be pressurized to withstand internal pressures of chamber 112. Alternatively, buoyant stopper 206 may be a solid sphere made from a material with a lower density than that of water.

In the illustrated embodiment, chamber 112 is spherical; however, other shapes may be used for chamber 112 without departing from the scope hereof. Chamber 112 may be fabricated as two hollow hemispheres to facilitate inclusion of buoyant stopper 206. Once buoyant stopper 206 is inserted, the two hemispheres may be joined together, for example by welding, screwing, heat staking, or press fitting.

In one embodiment, chamber 112 is formed of two hollow hemispheres, each of which is threaded to couple together. Such construction facilitates assembly and allows chamber 112 to be dismantled for repair and/or cleaning.

In another embodiment, chamber 112 is formed of a left and a right hollow, half conical shape, which are welded together. This shape facilitates the funneling of water 208 and buoyant stopper 206 toward outlet 205 when the axis of symmetry of the conically shaped chamber 112 is not parallel with the pull of gravity (e.g. the compressed air cylinder 100 is on a hill).

In yet another embodiment, the diameters of buoyant stopper 206 and outlet 205 in combination with the buoyancy of buoyant stopper 206 are such that buoyant stopper 206 will not be unseated from seat 210 when air pressure 213 is above a predetermined value. This embodiment may be designed to discharge water 208 from chamber 112 only when air cylinder 100 is decompressed.

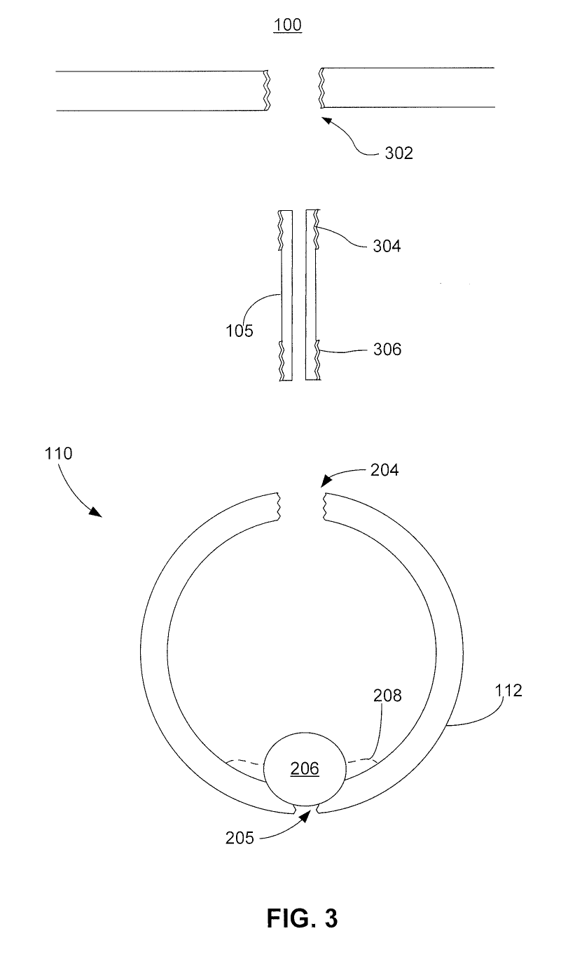

FIG. 3 is an exploded view illustrating use of threaded pipe 105 to connect float-based automatic drain valve 110 to compressed air cylinder 100. A threaded aperture 302 of compressed air cylinder 100 connects to thread 304 of pipe 105 and threaded inlet 204 of chamber 112 connects to thread 306 of pipe 105, thereby pressurewise connecting chamber 112 to compressed air cylinder 100.

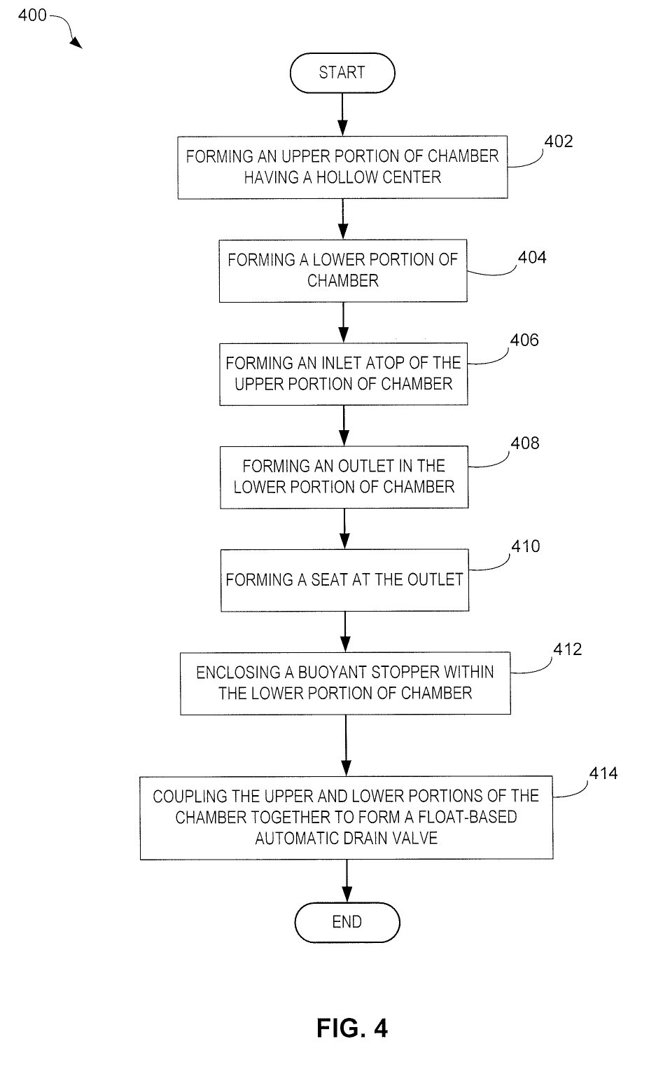

FIG. 4 is a flowchart illustrating one exemplary process 400 for manufacturing float-based automatic drain valve 110 of FIG. 1. In step 402, process 400 forms an upper portion of chamber 112 having a hollow interior. In one example of step 402, a top half of chamber 112 is formed from stainless steel. In step 404, process 400 forms a lower portion of chamber 112 having a hollow interior. In one example of step 404, the lower half of chamber 112 is formed from stainless steel. In step 406, an inlet is formed at the top of the upper portion of chamber. In one example of step 406, an aperture is drilled into the top half of chamber 112 and then threaded to form inlet 204. In step 408, process 400 forms an outlet in the lower portion of chamber. In one example of step 408, a hole is drilled into the lower half of chamber 112, formed in step 406, to form outlet 205. In step 410, process 400 forms a seat at the outlet. In one example of step 410, seat 210 is milled (or ground) into an inside edge of outlet 205; optionally a sealing ring is attached to the seat in this step. In step 412, process 400 encloses a buoyant stopper within the lower portion of chamber. In one example of step 412, buoyant stopper 206 is placed within the lower half of chamber 112, formed in step 404. In step 414, process 400 couples upper and lower portions of the chamber together to form a float-based automatic drain valve. In one example of step 414, the two halves of steps 402 and 404 are joined together to encapsulate buoyant stopper 206, and then the two halves are welded together to form chamber 112.

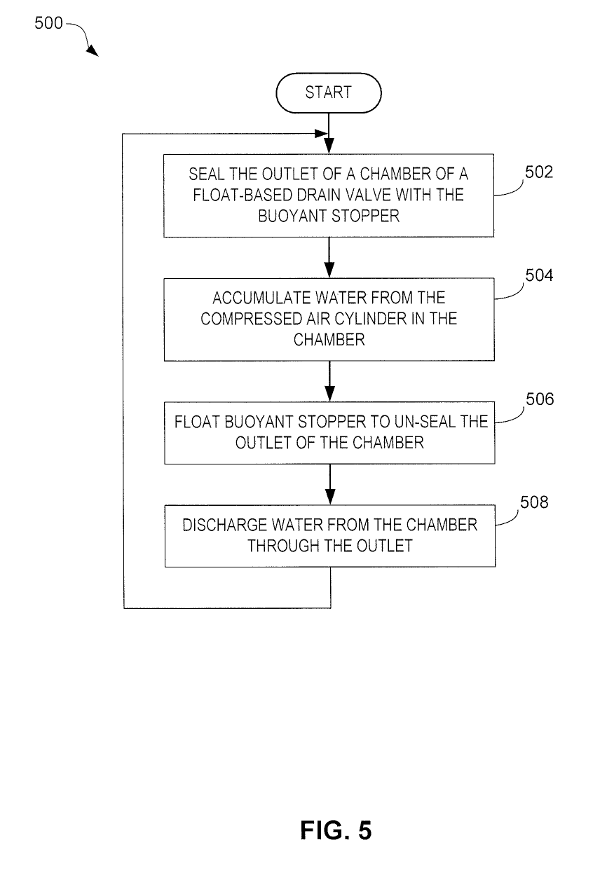

FIG. 5 is a flowchart illustrating one exemplary process 500 for automatically draining water 208 from compressed air cylinder 100 using float-based automatic drain valve 110 of FIG. 1. In step 502, process 500 seals the outlet of a chamber of drain valve 110 with the buoyant stopper. In one example of step 502, gravity causes buoyant stopper 206 to settle at seat 210 of outlet 205, thereby sealing it. In step 504, process 500 accumulates water from the compressed air cylinder within the chamber. In one example of step 504, water 208 condenses within compressed air cylinder, flows through pipe 105 and is accumulated within chamber 112. In step 506, process 500 floats buoyant stopper to un-seal the outlet of the chamber. In one example of step 506, buoyancy 211 of buoyant stopper 206 overcomes the forces of gravity 212 and differential air pressure 213, 214 to float buoyant stopper away from outlet 205. In step 508, water is discharged from the chamber. In one example of step 508, water 208 is forced out of chamber 112 via outlet 205 by air pressure 213.

Steps 502-508 repeat as water accumulates within, and is expelled from, chamber 112. For example, water 208 is expelled from chamber 112 via outlet 205 until buoyancy 211 of buoyant stopper 206 no longer exceeds the forces of gravity 212 and pressure differential 213, 214.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present methods and systems, which, as a matter of language, might be said to fall there between.

What is claimed is:

1. A float-based automatic drain valve automatically drains fluid from a compressed air cylinder, comprising:
a chamber with an inlet and an outlet, the inlet being formed at the top of the chamber that connects to a low point of the compressed air cylinder to receive a fluid therefrom, and the outlet being formed at the bottom of the chamber for discharging the fluid; and
a buoyant stopper disposed within, and not attached to, the chamber, for (a) sealing the outlet when insufficient fluid is present within the chamber, and (b) unsealing the outlet when buoyancy of the stopper within the fluid overcomes forces seating the buoyant stopper at the outlet.

2. The float-based automatic drain valve of claim 1, wherein the forces sealing the buoyant stopper at the outlet comprise gravity and differential air pressure of compressed air within the chamber to atmospheric pressure outside the chamber.

3. The float-based automatic drain valve of claim 1, the chamber attaching to the compressed air cylinder by an externally threaded pipe.

4. The float-based automatic drain valve of claim 1, further comprising a seat formed at the inside of the outlet to receive the buoyant stopper.

5. The float-based automatic drain valve of claim 4, further comprising one or more sealing rings attached to the seat to improve seal between the buoyant stopper and the outlet.

6. The float-based automatic drain valve of claim 1, the buoyant stopper formed of a solid sphere of material having a density lower than the density of the fluid.

7. The float-based automatic drain valve of claim 1, the buoyant stopper formed of a hollow sphere of material such that the buoyant sphere floats in fluid.

8. The float-based automatic drain valve of claim 1, the buoyant stopper formed from one or more of polypropylene, anti-corrosive metal, and plastic.

9. The float based automatic drain valve of claim 1, the density of the buoyant stopper, the diameter of the buoyant stopper, and the diameter of the outlet are selected to allow the draining of fluid from the chamber at an internal air pressure less than the maximum internal air pressure.

10. The float-based automatic drain valve of claim 1, the chamber being formed from one or more of stainless steel, anti-corrosive metals, polypropylene and plastic.

11. A method manufactures a float-based automatic drain valve for a compressed air cylinder, comprising:
forming an upper portion of a chamber with a hollow interior;
forming a lower portion of the chamber with a hollow interior;
forming an inlet at the top of the upper portion of the chamber;
forming an outlet at the bottom of the lower portion of the chamber;
forming a seat at the inside of the outlet;
placing a buoyant stopper within the lower portion of the chamber; and
joining the upper and lower portions of the chamber to encapsulate the buoyant stopper.

12. The method of claim 11, the step of joining comprising welding the upper and lower portions of the chamber together.

13. The method of claim 11, the step of joining comprising screwing the upper and lower portions of the chamber together.

14. The method of claim 11, the step of joining comprising heat staking the upper and lower portions of the chamber together.

15. The method of claim 11, the step of joining comprising press-fitting the upper and lower portions of the chamber together.

16. The method of claim 11, further comprising attaching the chamber to a compressed air cylinder using a threaded pipe.

17. A method drains fluid from a compressed air cylinder using a float-based automatic drain valve, comprising:
sealing an outlet of a chamber of the float-based automatic drain valve with a buoyant stopper;
accumulating fluid from the compressed air cylinder in the chamber;
floating, with the fluid, the buoyant stopper to un-seal the outlet; and
discharging fluid from the chamber through the outlet.

18. The method of claim 17, the step of floating comprising floating the buoyant stopper when the buoyant force from the accumulated fluid overcomes the forces of gravity and differential air pressure between the compressed air within the chamber and atmospheric pressure.

19. The method of claim 18, further comprising re-sealing the outlet of the chamber with the buoyant stopper when insufficient fluid remains within the chamber to float the buoyant stopper.

20. An air cylinder system, comprising:
a cylinder for holding compressed air; and
a float-based automatic drain valve that is in fluid communication with the cylinder, the float-based automatic drain valve forming a chamber into which fluid from the cylinder drains and a buoyant stopper which (a) seals the chamber to prevent fluid and compressed air draining from the chamber if there is insufficient fluid to float the buoyant stopper within the chamber and (b) unseals the chamber, such that fluid drains from the chamber, if the buoyant stopper floats in the fluid within the chamber.

21. The air cylinder system of claim 20, further comprising a pipe for connecting an aperture of the tank to an inlet of the float-based automatic drain valve.

22. The air cylinder system of claim 20, the float-based automatic drain valve forming an outlet which, when the buoyant stopper rests on the outlet, seals the chamber to prevent fluid and compressed air draining from the chamber.

23. The air cylinder system of claim 20, further comprising an air compressor for compressing air within the cylinder.
